(19) United States
(12) Patent Application Publication
(10) Pub. No.: US 2026/0225343 A1
(43) Pub. Date: Aug. 6, 2026

(54) FAUX NEOPRINE TEXTILE

(71) Applicant: Target Brands, Inc., Minneapolis, MN (US)

(72) Inventor: Kira E. Wong, Goleta, CA (US)

(21) Appl. No.: 19/045,763

(22) Filed: Feb. 5, 2025

(51) Int. Cl. B32B 5/24; B32B 5/02; B32B 5/18; B32B 7/02; B32B 25/04; B32B 25/14; B32B 37/10; B32B 37/12; B32B 37/24; D04B 1/16; D04B 1/22

(52) U.S. Cl. CPC B32B 5/245; B32B 5/026; B32B 5/18; B32B 7/02; B32B 25/045; B32B 25/14; B32B 37/10; B32B 37/12; B32B 37/24; D04B 1/16; D04B 1/22; B32B 2037/243; B32B 2255/02; B32B 2262/0276; B32B 2266/0278; B32B 2305/022; B32B 2305/186; B32B 2307/7265; B32B 2307/7376; B32B 2309/02; B32B 2367/00; B32B 2375/00; B32B 2439/06; D10B 2331/04; D10B 2505/10

(57) ABSTRACT

A textile for use in forming an article and a method of producing the textile, the textile having a first layer comprising a recycled polyester material having a first thickness; and a second layer comprising a polyurethane foam having a second thickness, wherein the first thickness is less than the second thickness and wherein the first layer and the second layer are adhered together.

### BACKGROUND

Synthetic rubbers such as Neoprene are general-purpose rubbers are valued for high tensile strength, resilience, oil and flame resistance, and resistance to degradation by oxygen and ozone. However, this material is expensive and energy intensive to produce, limiting its application to specialized products. Neoprene is a petroleum-based product with negative environmental impacts resulting from its production. The manufacturing process for Neoprene also uses toxic chemicals and the waste products are known to contaminate water supplies.

### SUMMARY

An aspect of the present disclosure relates to a textile for use in forming an article where the textile comprises a first layer comprising a recycled polyester material having a first thickness and a second layer comprising a polyurethane foam having a second thickness, wherein the first thickness is less than the second thickness and wherein the first layer and the second layer are adhered together.

The recycled polyester material comprises a jersey fabric, a jersey knit fabric, air-mesh, crinkle nylon, a nylon fabric, heather jersey, faux nylon, faux nylon woven, or a woven polyester.

In one or more embodiments, a water-repellent layer is provided on an exterior surface of the first layer.

In one or more embodiments, the first layer and the second layer are adhered directly together with only adhesive therebetween. In some embodiments with an adhesive layer therebetween, the adhesive layer does not contribute an overall thickness of the textile. In some embodiments the first layer and the second layer are heat bonded together substantially across the surface area of the textile.

The textile has an overall thickness of 2.5 mm to 3.55 mm. In one or more embodiments, the second thickness is at least two times greater than the first thickness.

The article is a bag or portable container. The textile is a backpack, carryall, satchel, handbag, shoulder bag, cosmetic case, or lunch box.

In one or more embodiments, the first layer comprises a jersey knit fabric with the first thickness in the range of 0.5 mm to 0.6 mm and the second layer comprises the polyurethane foam with the second thickness in the range of 1.8 mm to 2.7 mm and wherein an adhesive layer adheres the first layer directly to the second layer.

Another aspect of the present disclosure relates to a bag constructed from a textile comprising a first layer comprising a recycled polyester material having a first thickness; and a second layer comprising a polyurethane foam having a second thickness, wherein the first thickness is less than the second thickness and wherein the first layer and the second layer are adhered together.

The bag further comprises a water-repellent layer on an outer surface of the first layer.

A liner is provided adjacent to an outer surface of the second layer, opposite the first layer, and the liner comprises elastane.

In one or more embodiments the second layer is at least three times as thick as the first layer.

Another aspect of the present disclosure relates to a method of producing a textile for constructing a bag comprising adhering a recycled polyester material layer to a layer of polyurethane foam; adding a liner to the layer of polyurethane foam on a side of the polyurethane foam opposite the recycled polyester material; and applying a water-repellent coating to a side of the recycled polyester material layer opposite the polyurethane foam.

In one or more embodiments the textile is produced by heat pressing the recycled polyester material layer and the polyurethane foam layer together at about 200° C. to higher to facilitate bonding of the layers.

### BRIEF DESCRIPTION OF THE DRAWINGS

FIG. 1 is a side view of a textile according to one or more embodiments herein.

FIG. 2 is a side view of another embodiment of the textile according to one or more embodiments described herein.

FIG. 3 is an article formed with the textile according to one or more embodiments described herein.

### DETAILED DESCRIPTION

A textile is described herein where the textile shares many of the valued properties of Neoprene in that the textile according to one or more embodiments described herein is strong, durable, resistant to heat and weathering, and easily cleanable. The textile described herein may be produced using recycled materials. The textile disclosed herein is distinct from Neoprene in that the textile does not include components produced by the polymerization of chloroprene, and thus eliminates the toxic materials used and/or byproducts from the production of the textile. Moreover, the textile is not a synthetic rubber. In contrast, materials of increased sustainability are layered to form the unique and versatile textile described herein.

The textile according to one or more embodiments herein may be used in the formation of various articles for personal use. By way of non-limiting example, the textile can be used in the formation of backpacks, bags, carryalls, lunch boxes, cosmetic bags, toiletry bags and the like. The textile can be used and/or incorporated into various products that are subjected to wear and tear, moisture, food products, self-care products, sharp items or the like. The textile is easily cleanable, water resistant, colorfast, and is durable for continued wear, use and/or heavy use. When using the textile to form an article, the textile according to one or more embodiments described herein may be paired with a liner.

Further, the textile may have one or more surfaces provided with a water-repellent coating. The water-repellent coating may be a wax-based repellent, silicone-base repellent, fluorocarbon-based repellent or other material applied to the textile and configured to lower the surface free energy of the textile to lower than water surface tension to decrease the wetting ability and increase the water repellency of the textile.

As such, the textile may be a multi-layer textile provided with an additional liner of the same or different composition. For example, the liner may comprise elastane (spandex).

The textile according to one or more embodiments described herein may be a multi-layer textile comprised of a first layer and a second layer that are adhered directly together. The first and second layer may be adhered across the entire surface area of the layers to form an integrated textile.

The first layer, also referred to herein as a top layer, may be comprised of a recycled material. The first layer may be comprised of a recycled polyester material or fabric. The recycled polyester may be recycled post-consumer polyester, and/or polyester derived from recycled plastic bottles.

The second layer, also referred to herein as a bottom layer may be a foam layer. The foam layer may be an open or closed cell foam. The second layer may be a polyurethane foam layer.

The textile may have an overall thickness greater than 1 mm. The textile may have a thickness in the range of 2.5 mm to 3.5 mm, or more preferably in the range of 2.8 mm to 3.3 mm, or more preferably in the range of 3.0 mm to 3.1 mm. The recycled polyester layer, the first layer, may have a thickness in the range of 0.50-0.60 mm, or for example, about 0.55 mm and the second layer may have a thickness in the range of 1.75 mm to 2.75 mm, or more preferably in the range of 2.0 mm-2.55 mm. The adhesive layer may generally be negligible in thickness and/or have no substantial or actual measurable thickness. The first layer and the second may have the same or different thicknesses and for example, the second layer may have a greater thickness than the first layer.

In one or more embodiments, the first layer comprises a recycled fabric layer comprised of a recycled polyester. The recycled polyester may comprise a jersey knit fabric, jersey fabric in varying percentages of fiber content, an air-mesh, a crinkle nylon, nylon fabrics, heather jersey, faux nylon and/or woven faux nylon, a woven polyester or combinations thereof.

The second layer may then comprise a foam material such as polyurethane foam. The foam may be a high-density polyurethane foam, a high-density sponge or open cell foam, or in some embodiments a closed cell polyurethane foam. Non-limiting examples of the polyurethane foam include high resilience open cell foams with a density in the range of 2.8 to 3.2, a lux foam which is an open cell foam having a density in the range of 2.0-2.4, or a high-density polyurethane foam having a density in the range of 1.9-2.4 or blends thereof.

The first and second layer may then be adhered together with an adhesive layer therebetween. It is also contemplated that other manners of securing the first and second layer together are possible, including heat bonding. In making the textile, the first or top layer is adhered directly to the second or bottom layer with an application of adhesive therebetween via spray, rolling or other methods. The adhesive may be a pressure sensitive adhesive. Additionally, or alternatively, the layers may be heat bonded together. In one embodiment, the textile is formed by heat pressing the top layer and the bottom layer together at approximately 200° C. to facilitate bonding of the layers with the adhesive therebetween.

The first layer may also be optionally provided with a water-repellent coating.

Once forced, the textile does not crease, is more flexible and is produced at a lower cost than Neoprene and most significantly, without the toxic chemicals. The textile may be used as a shell for various style bags and other personal use items.

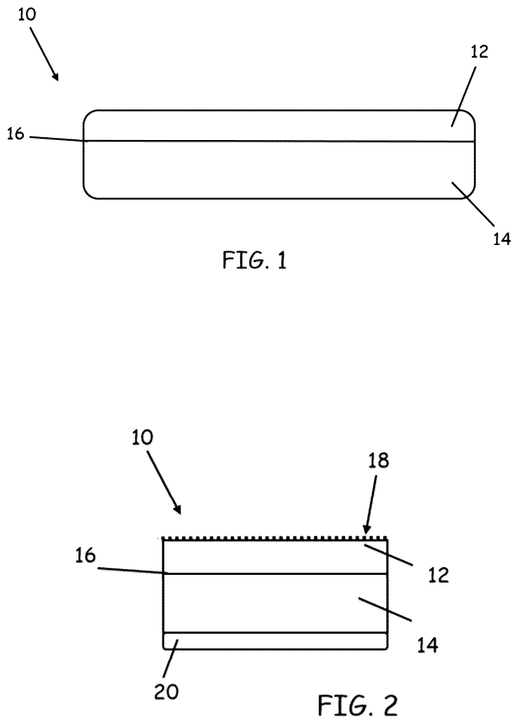

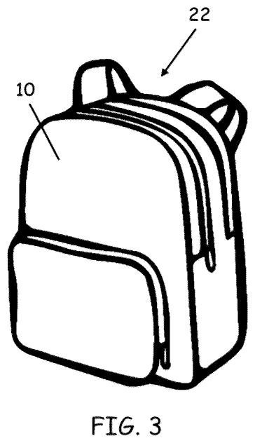

As illustrated in FIG. 1, in one embodiment a textile 10 comprises a first layer 12 comprised of a jersey knit fabric. A second layer 14 comprises polyurethan foam. The layers 12 and 14 are secured together across the respective surface areas with an adhesive layer 16 therebetween. The adhesive bonds the first layer 12 and second layer 14 together without contributing to the overall thickness of the textile.

The first layer 12 is a top layer having a thickness of about 0.55 mm. The second layer 14 is a bottom layer having a thickness of about 2.5 mm. The adhesive does not substantially contribute to overall thickness of the textile and thus the first layer 12 and second layer 14 form a textile having a thickness of about 3.1 mm.

As illustrated in FIG. 2, the textile 10 is provided with a liner 18 and water-repellent coating 20 to form a textile shell for an article 22 such as a bag.

Although the subject matter has been described in language specific to structural features and/or methodological act, it is to be understood that the subject matter defined in the appended claims is not necessarily limited to the specific features or acts described above. Rather, the specific features and acts described above are disclosed as example forms for implementing the claims.

What is claimed is:

1. A textile for use in forming an article, the textile comprising:
a first layer comprising a recycled polyester material having a first thickness; and
a second layer comprising a polyurethane foam having a second thickness,
wherein the first thickness is less than the second thickness and wherein the first layer and the second layer are adhered together.

2. The textile of claim 1 wherein the recycled polyester material comprises a jersey fabric, a jersey knit fabric, air-mesh, crinkle nylon, a nylon fabric, heather jersey, faux nylon, faux nylon woven, or a woven polyester.

3. The textile of claim 1 and further comprising a water-repellent layer provided on an exterior surface of the first layer.

4. The textile of claim 1 wherein the first layer and the second layer are adhered directly together with only adhesive therebetween.

5. The textile of claim 1 wherein the first layer and the second layer are heat bonded together substantially across the surface area of the textile.

6. The textile of claim 1 and further comprising an adhesive layer therebetween, the adhesive layer not contributing an overall thickness of the textile.

7. The textile of claim 1, and further comprising an overall thickness of 2.5 mm to 3.55 mm.

8. The textile of claim 1, wherein the second thickness is at least two times greater than the first thickness.

9. The textile of claim 1, wherein the article is a bag or portable container.

10. The textile of claim 9, wherein the article is a backpack, carryall, satchel, handbag, shoulder bag, cosmetic case, or lunch box.

11. The textile of claim 1 wherein the first layer comprises a jersey knit fabric with the first thickness in the range of 0.5 mm to 0.6 mm and the second layer comprises the polyurethane foam with the second thickness in the range of 1.8 mm to 2.7 mm and wherein an adhesive layer adheres the first layer directly to the second layer.

12. A bag constructed from a textile comprising a first layer comprising a recycled polyester material having a first thickness; and a second layer comprising a polyurethane foam having a second thickness, wherein the first thickness is less than the second thickness and wherein the first layer and the second layer are adhered together.

13. The bag of claim 12, and further comprising a water-repellent layer on an outer surface of the first layer.

14. The bag of claim 12, and further comprising a liner adjacent to an outer surface of the second layer, opposite the first layer, wherein the liner comprises elastane.

15. The bag of claim 12 wherein the second layer is at least three times as thick as the first layer.

16. A method of producing a textile for constructing a bag comprising:
adhering a recycled polyester material layer to a layer of polyurethane foam;
adding a liner to the layer of polyurethane foam on a side of the polyurethane foam opposite
the recycled polyester material; and
applying a water-repellent coating to a side of the recycled polyester material layer
opposite the polyurethane foam.

17. The method of claim 16 and further comprising producing the textile by heat pressing the recycled polyester material layer and the polyurethane foam layer together at about 200°C to higher to facilitate bonding of the layers.
